(19) United States
(12) Patent Application Publication
(10) Pub. No.: US 2017/0368844 A1
(43) Pub. Date: Dec. 28, 2017

(54) TREATING A FIBROUS MATERIAL FOR PRINTING

(71) Applicant: MS Printing Solutions S.R.L., Caronno Pertusella (VA) (IT)

(72) Inventor: Luigi Milini, Saronno (IT)

(21) Appl. No.: 15/699,825

(22) Filed: Sep. 8, 2017

(30) Foreign Application Priority Data
Mar. 9, 2015 (IT) MI2015A000355

(51) Int. Cl. B41J 11/00; B41J 3/407; F26B 13/10; B41M 5/00

(52) U.S. Cl. CPC B41J 11/007; F26B 13/101; B41J 3/4078; B41J 11/0015; B41M 5/0047; B41M 5/0017

(57) ABSTRACT

An apparatus and method for treating a sheet fibrous material to be printed with ink. The apparatus includes a conveyor belt movable along a closed path including an operative section defining a plurality of bends, an inlet station that receives the sheet fibrous material and adheres a first side of the material to an exposed surface of the conveyor belt, a drying station placed at the operative section and configured to at least partially dry the sheet fibrous material, and an applicator for applying a wet treatment agent to the material prior to drying.

### CROSS-REFERENCE TO RELATED APPLICATIONS

This application is a continuation of and claims priority to PCT Application Serial No. PCT/IB2016/051301, filed on Mar. 8, 2016, the entire contents of which are incorporated herein by reference.

### FIELD OF THE INVENTION

The present invention refers to an apparatus and associated process for treating a sheet-form fibrous material, such as a fabric and/or a non-woven fabric, destined to print, for example digital print. The invention can be applied in the textile industry for preparing knitted, woven or non-woven fabrics for printing, for example by digital-type printing.

### BACKGROUND

Conventional printing—in other words, using cylinders or printing silk-screen frames—and digital-type printing—in other words, using one or more nozzle printing heads—are technologies used for applying inks or paints defining motifs, patterns, colorations on different types of sheet materials such as, for example, paper, fabrics, non-woven fabrics, felt, etc.

The fabrics, non-woven fabrics, or other fibrous materials having a laminar structure destined to be subject to conventional or digital printing are subjected to a series of preparation steps, before being printed, and to one or more steps of finishing the fabric after printing.

More particularly, it is noted that a suitable pre-treatment of at least the fibrous material surface, before printing, causes the ink to be deposited in the desired way and place, and to be suitably fixed to the fibrous material itself. For example, the fibrous material to be printed can be treated with substances afterward adapted to enable suitably fixing the printing colors: these treatments are for example performed with alkali-based or acid-based (according to the type of ink afterwards applied), thickener-based, antimigrant-based and/or wetting agent-based substances.

These substances and the associated pre-treatment processes are known and used in the textile field, and—generally—vary as a function of the fabric and type of the printing ink. The pre-treatment enables the ink drops to be fixed on the fibers of the material to be treated without forming marks and spreading around in an uncontrolled manner: the preliminary step of treating the fabric therefore ensures a good color yield and a suitable definition.

Specifically, in the digital printing processes, suitable pre-treatment of the material to be printed has a crucial importance. In digital printing, jet heads having a plurality of nozzles with small ink passage opening are used, and it is virtually impossible to directly add additive to the ink because the ink could become much too viscous, which would prevent controlling the ink passage through the heads, or could develop chemical or physical properties that are not easily manageable by the systems controlling the digital print heads. Due to this reason, a fibrous material to be digitally printed is generally appropriately treated before printing. Application of the above-described pre-treatment substances is typically done by immersion or by spraying, either of which leave the material to be printed wet, or at least moist. Therefore, before printing and after applying the additive, the material typically must be dried.

### SUMMARY OF THE INVENTION

One aspect of the invention features a fibrous sheet material printing pre-treatment apparatus, including a conveyor belt movable along a closed path and having an exposed surface configured for receiving the fibrous sheet material, at least a portion of the closed path of said conveyor belt defining an operative section defining a plurality of bends. The apparatus also has an adhesive applicator configured to place on a first side of the sheet material and/or on an exposed surface of the conveyor belt, an adhesive capable of constraining the fibrous sheet material to the conveyor belt, and a drying station operable over at least a portion of said operative section and configured to at least partially dry fibrous sheet material in the operative section. The drying station has a casing defining treating chamber in which the operative section extends, the casing defining an inlet port enabling continuous passage of the conveyor belt into the treating chamber, and an outlet port spaced from the inlet port and enabling continuous passage of the conveyor belt out of the treating chamber. A length of the operative section within the treating chamber is greater than a maximum distance between the inlet port and the outlet port of the casing.

In some embodiments, the adhesive applicator is configured to apply a continuous layer of adhesive material only on the exposed surface of the conveyor belt, the applied layer having a width at least equal to a width of the fibrous sheet material to be printed.

In some examples, the drying station includes one or more airflow generators configured to direct one or more flows of gas to impinge upon an exposed surface of the fibrous sheet material fixed to the conveyor belt.

In some cases, the apparatus includes a plurality of intermediate idlers disposed inside treating chamber and active on the operative section, including a first group of intermediate idlers aligned according to a first row and a second group of intermediate idlers aligned according to a second row, said first and second rows positioned at different heights to define within the operative section a plurality of alternating ascending and descending sections along which the conveyor belt is constrained to travel in a series of bends.

In some embodiments, the drying station is configured to blow air against the fibrous sheet material between adjacent bends. For example, the drying station may include, for each of a plurality of said bends, a respective distribution channel positioned within the bend and configured to emit a gas flow toward the fibrous sheet material. In some cases, the drying station has an inlet conduit connected to one or more airflow generators and to the distribution channels, said inlet conduit configured to supply a gas flow to each distribution channel. The inlet conduit defines an inlet opening adapted to receive a gas flow from the one or more airflow generators and positioned at the top of the treating chamber, service openings connected to respected ones of the distribution channels and configured to supply gas to the distribution channels, and a gas passage cross-section that decreases from the inlet opening along an airflow direction.

In some examples, the conveyor belt has a width greater than a maximum width of the fibrous sheet material, and includes dragging portions arranged to extend laterally beyond opposite longitudinal sides of the fibrous sheet material. The apparatus also includes a dragging device active on the dragging portions and configured to move the conveyor belt without contacting the exposed surface of the belt. In some cases, at least some of the intermediate idlers have guiding portions engageable by the dragging device to move the guiding portions and thereby move the conveyor belt at least along the operative section.

In some embodiments, wherein the exposed surface of the conveyor belt is advantageously devoid of through openings passing through the belt.

The apparatus may also include a control unit active on the conveyor belt and the drying station, and configured to control both movement of conveyor belt and a gas emission directed to said operative section within the drying station.

In some embodiments, the apparatus also includes at least one treatment applicator configured to apply on a second side of the fibrous sheet material, opposite the first side, a treatment liquid or treatment foam. The treatment applicator may include, for example, a spreading blade placed across the conveyor belt and above the fibrous sheet material, a spray dispenser spaced above the fibrous sheet material, an applicator roll with an associated blade adapted to regulate a thickness of treatment foam deposited on a lateral surface of the applicator roll, the roll spaced above the fibrous sheet material and having a rotation axis transverse to the conveyor belt, a drum spaced above the fibrous sheet material and having a rotation axis transverse to the conveyor belt, the drum having a hollow interior configured to receive a predetermined quantity of treatment foam and a number of nozzles or slits for dispensing foam from the interior, or a distributor comprising a tank configured to receive a predetermined quantity of treatment foam and having a dispensing nozzle defining an outlet of the tank, the nozzle extending transverse to the conveyor belt over an entire width of the belt, the distributor having a pump disposed inside the tank and configured to supply the treatment foam through the nozzle.

Another aspect of the invention features a method of treating a fibrous sheet material. The method includes moving a conveyor belt along a closed path, fixing at least temporarily a first side of a fibrous sheet material to an exposed surface of an operative section of the conveyor belt, at least partially drying the fibrous sheet material by blowing gas on the fibrous sheet material during passage of the fibrous sheet material along bends defined by the operative section, and then withdrawing the fibrous sheet material from the conveyor belt. Moving the conveyor belt includes moving the conveyor belt inside a treatment chamber, from an inlet port to an outlet port, such that the operative section extends at least partially inside the chamber, and a length of the operative section within the treatment chamber is greater than a maximum distance between the inlet port and the outlet port.

In some examples, fixing the fibrous material to the conveyor belt includes applying an adhesive material on at least a portion of the exposed surface of the conveyor belt during the movement of the conveyor belt along the closed path, and contacting a first side of the fibrous sheet material with the applied adhesive material while continuously moving the conveyor belt along the closed path.

Preferably, the conveyor belt is moved at a predetermined speed selected to subject a given section of the fibrous sheet material to a drying gas flow emission for a time between 30 and 240 seconds.

In some embodiments the method includes, after fixing the fibrous sheet material and before blowing the gas, applying on a second side of the fibrous sheet material, opposite the first side, a wet treatment material. The wet treatment material may be, for example, a treatment foam.

In some cases, the method includes dispensing a predetermined quantity of the foam with a spray dispenser, or spreading a predetermined quantity of foam with a spreader. The spreader may be, for example, a spreading blade transversally arranged to the motion of the conveyor belt, an applicator roll having an associated respective spreading blade for regulating a thickness of the treatment foam deposited on a lateral surface of the applicator roll, said applicator roll having a lateral surface spaced above the conveyor belt and a rotation axis transverse to the conveyor belt, or a drum having a lateral surface spaced above the conveyor belt and a rotation axis transverse to the conveyor belt, the drum defining a hollow interior configured to receive a predetermined quantity of treatment foam and defining a predetermined number of nozzles or slits for dispensing treatment foam from the interior.

In some cases, the method includes dispensing a predetermined quantity of foam with a distributor having a tank configured for receiving the treatment foam, the tank having at least one dispensing nozzle defining an outlet of the tank and extending across an entire width of the conveyor belt, and a pump configured to supply treatment foam from the tank through the nozzle In some examples, the foam includes a treatment liquid in a quantity between 5% and 75% in weight with respect to the total weight of the foam. In some cases the treatment liquid includes at least one anti-migration agent, preferably selected among alginates, cellulose derivatives, particularly carboxymethylcellulose, hydroxyethylcellulose, acrylic (co)polymers, xanthan gum, Arabic gum and guar gum, and/or a fixing agent, particularly said fixing agent comprising at least one pH-control agent, preferably selected among sodium bicarbonate, sodium carbonate, ammonium sulfate, ammonium tartrate and citric acid, and at least one hydrotropic agent, preferably selected between urea and thiourea, at least one foaming agent in a weight percentage between 0.2% and 5%, preferably between 0.4% and 2%, with respect to the total foam weight, and water in a quantity needed to reach 100%.

As used herein, the following terms have the following intended meanings.
Ink: a mixture formed by a dispersion of pigments or by a solution of dies in an aqueous or organic medium destined to be transferred on surfaces of different materials for obtaining one or more prints; it is understood that are also comprised clear inks and paints.
Fibrous material: a material consisting of fibers of a variety of types, for example a fabric, a non-woven fabric, a knitted fabric, or combinations of one or more of said supports.
Sheet fibrous material: a fibrous material as hereinbefore defined, formed in a structure having two dimensions (length and width) having both a markedly prevalent extension with respect to a third dimension (thickness). The term “sheet fibrous material” means both a fibrous material in discrete sheets having limited lengths (for example the formats A0, A1, A2, A3, A4, etc.), and continuous bands exhibiting a marked length which can be supplied by a roll on which the sheet material is reeled or can come from an in-line printing step. In any case, the sheet fibrous material, herein described, exhibits two sides, or main surfaces, on at least one of which is printed or to be printed.
Digital printing: a printing using one or more nozzle printing heads for applying inks defining motives, patterns, colorations, etc., on sheet materials. The printing heads can be movable transversally to the sheet material advancement direction, in order to cover the overall width to be printed, or can be transversally stationary, when the heads width is equal to the printing width, in other words the fabric.
Treatment liquid: comprises one or more liquid compounds, or one or more compounds dissolved or dispersed in a suitable liquid phase, having the function of pre-treating at least the surface or surfaces of the sheet fibrous material, destined to receive one or more prints. The compounds can be from a natural and/or synthetic sources (polymers and/or copolymers) and having one or more of the following functions: antimigrant, thickener, modifier of the surface tension, acidity modifier, hydrophilicity modifier, drying accelerator, fixing enhancer. The liquid phase can be aqueous or polymeric.
Treatment foam: a dispersion of a gas in a liquid; moreover, the foam may have colloidal-dispersion characteristics. The foam may be obtained by directly blowing high pressure gas in a liquid or using foaming agents.

Treatment foam may include a treatment liquid as described above and, optionally, one or more additives such as: foaming agents, wetting agent and viscosity modifier agent. Foaming agents are known to the skilled person and for instance include surfactants, for example cationic, anionic, amphoteric, non-ionic surfactants; for example, alkyl betaines, in particular laurilamidopropilbetaine may be used. Suitable wetting agents include for example silicone derivatives. Viscosity modifying agents include for example, modified or replaced cellulose and poly(meth)acrylics acids and their salts, such as ammonium salts, preferably: hydroxyethylcellulose, carboxymethylcellulose and cellulose dimethylpropane sulfonate.

The composition forming the treatment foam may for example comprise:
treatment liquid in a percentage between 5% and 75%, preferably between 10% and 60% by weight with respect to the total weight of said composition,
at least a foaming agent in a percentage between 0.2% and 5%, preferably between 0.4% and 2% by weight with respect to the total weight of said composition, and
water to reach 100%.

If present, the wetting agent is present in the composition of the treatment liquid used to produce the foam in a percentage ranging between 0.001% to 5%, preferably from 0.01% to 1% by weight with respect to the total weight of said composition. If present, the viscosity modifying agent is present in the composition of the treatment liquid used to produce the foam in a percentage ranging between 0.001 to 5%, preferably from 0.01% to 1% by weight with respect to the total weight of said composition.

Means usable to produce foam are well known to the skilled person and many different means are commercially available. For example in case of use of direct blowing of high pressure gas (air) in the liquid medium and/or in case of use of foaming agents, the means for producing foam may be a mechanical stirrer, a conventional mixer, or a foaming machine.

The density of the treatment foam is greater than 0.005 g/cm³, preferably between 0.01 g/cm³ and 0.3 g/cm³. Foam density is determined by placing a specified volume of foam in a graduated laboratory cylinder of known weight, by determining the weight of the foam and calculating the density by the known volume and weight. The expansion ratio of the treatment foam, defined as the ratio between the weight of the liquid and the weight of an equal volume of foam prepared with the liquid, is between 2:1 and 6:1, preferably between 3:1 and 5:1.

The average diameter of the cells of the foam is preferably greater than 0.05 mm, more preferably between 0.08 and 0.5 mm. The average diameter of the foam cells was measured by placing a foam sample on a microscope slide, by observing under a microscope at a magnification of 32 times, and counting the number of cells in an area of 6.77 mm². In particular, the average diameter D of the cells measured in mm was determined by the equation:

D=2/√π*[(6.77)(Liquid Density-Foam Density)/cell number]̂1/2

Preferably the treatment foam includes treatment liquid in a percentage between 5 and 75% by weight with respect to the total weight of the foam. Such a treatment liquid may include at least one anti-migrant agent, preferably selected from alginates, cellulose derivatives, in particular carboxymethylcellulose, hydroxyethylcellulose, acrylic (co) polymers, xanthan gum, gum arabic and guar gum, and/or at least one agent for controlling the pH, preferably selected from sodium bicarbonate, sodium carbonate, ammonium sulfate), ammonium tartrate and citric acid, and at least one hydrotropic agent, preferably selected from urea and thiourea. The foam preferably also includes at least a foaming agent in a percentage between 0.2 and 5%, preferably between 0.4 and 2% by weight with respect to the total weight of the foam, and water as it lacks to reach 100%.

Some embodiments and some aspects of the invention will be described in the following with reference to the attached drawings given only in an indicative and therefore non-limiting way.

### BRIEF DESCRIPTION OF THE DRAWINGS

FIG. 1 is a lateral schematic view of an apparatus for pretreating a fibrous material.

FIG. 2 is a cross-sectional view, taken along line II-II in FIG. 1.

FIG. 3 is an enlarged detailed view of the cross-section of FIG. 2.

FIG. 4 is a schematic longitudinal cross-section of the apparatus;

FIG. 5 is an enlarged view of the inlet station of FIG. 4.

FIGS. 6-8 are enlarged views of variants of the inlet station.

FIGS. 9-11 are further detailed views of the longitudinal cross-section of FIG. 4;

FIGS. 12-16 show, according to a lateral schematic view, different types of applicator for supplying adhesive, and/or treatment liquid and/or treatment foam.

### DETAILED DESCRIPTION

Reference 1 generally indicates an apparatus for treating a fibrous material T having a sheet shape and destined to be printed, for example by digital printing. The apparatus 1 is useable for treating a sheet fibrous material, for example consisting of or comprising a fabric and/or a non-woven fabric, before an ink-printing process on at least one side of said sheet. Generally but in a non-limiting way, the apparatus 1 can be useful in the textile or knitted fabric or non-woven fabric industry for preparing a material to be ink-printed.

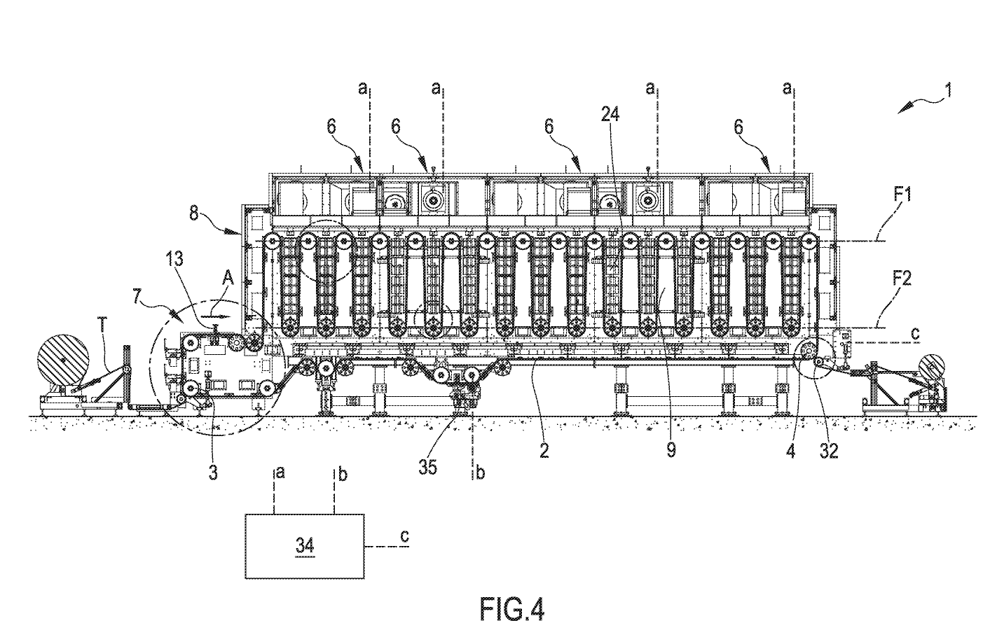

As is visible in FIG. 4, apparatus 1 comprises at least one conveyor belt 2 movable along a closed path, particularly between at least one first and one second terminal idler members 3, 4 along a predetermined advancement direction A. The conveyor belt 2 has a structure having two dimensions: length and width, substantially prevalent with respect to a third dimension, such as the thickness; the length is defined along the belt 2 advancement direction A, while the width is defined normal to direction A. The conveyor belt 2 is defined by a continuous layer having a substantially constant width and thickness along all the development of belt 2 itself.

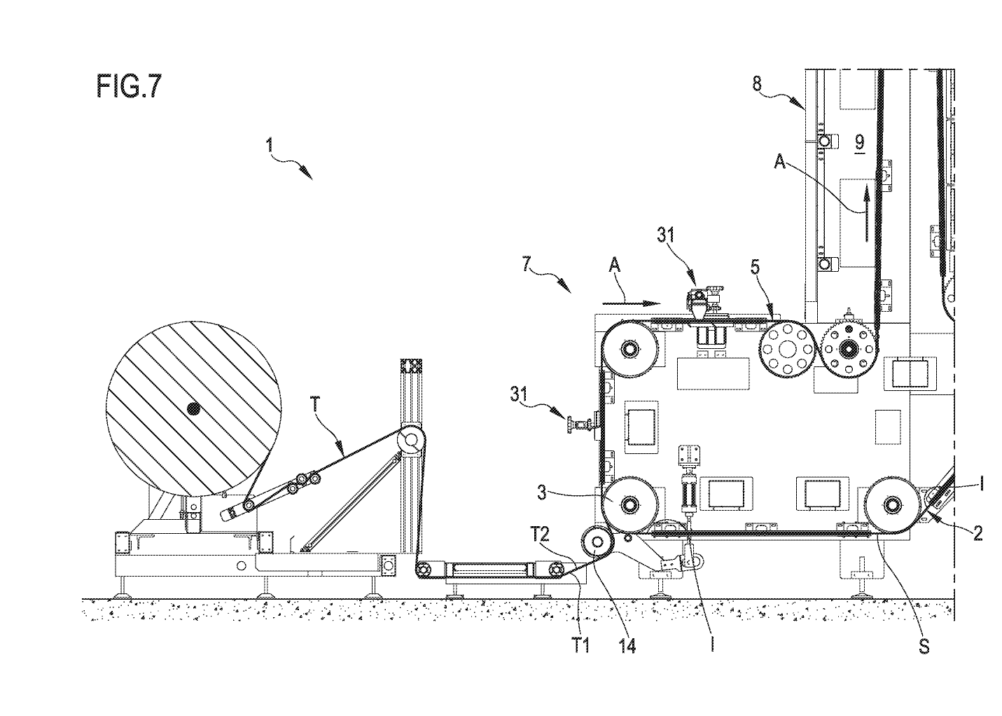

As shown in FIG. 5, conveyor belt 2 has two main surfaces or sides: an exposed surface S and an inner surface I. The inner surface I is configured for directly contacting the idler members adapted to guide the belt along the operative path 5, while the exposed surface S is configured for receiving the sheet fibrous material T; particularly, the exposed surface S is configured for facing and receiving a first side Ti of the sheet fibrous material T (see FIGS. 5-8, for example). In a preferred arrangement, conveyor belt 2—at least at a longitudinal continuous band of the exposed surface S destined to receive the sheet fibrous material T—is devoid of openings through the thickness of the belt 2; particularly at least the exposed surface S destined to receive the sheet fibrous material T is completely smooth and devoid of holes (through openings, for example) and advantageously devoid of valleys and projections. Advantageously, conveyor belt 2 comprises at least one continuous layer of a waterproof material defining the exposed surface S and capable of providing the surface S itself, along a view normal to a belt moving direction, with a continuous and preferably rectilinear outline.

As shown in the attached figures, at least a portion of the closed path of the conveyor belt 2 defines an operative section 5 conveying the sheet fibrous material T; actually, the operative section 5 is defined by the belt 2 portion moving the sheet fibrous material T, in other words by the belt portion 2 directly supporting said fibrous material T. The operative section 5 can be defined by a path portion between the first and second idler members 3, 4 or, as illustrated in FIG. 4, by the whole belt 2 portion between said members 3, 4: in this latter described arrangement, the operative section 5 substantially extends from the first idler member 3 to the second idler member 4. However, it is not excluded the possibility the operative section 5 could be defined by at least one belt 2 portion extending from the second idler member 4 in the direction of the first idler member 3.

The conveyor belt 2 can only comprise the first and second idler members 3, 4 and therefore have a substantially rectangular closed path, radiused in correspondence of said members; under such condition, the operative section could be defined by at least one rectilinear portion of the rectangular path: the sheet material T would be conveyed by the belt along a rectilinear section, particularly flat.

In a preferred arrangement, the operative section 5 of the conveyor belt 2 defines at least one or a plurality of bends (see FIG. 4, for example). Particularly, in this latter described arrangement, the operative section 5 defines, according to an operative condition of the apparatus 1 itself, a series of ups and downs with respect to the first and/or second idler member 3, 4. In other words, the operative section 5 has at least one ascending section 15 and at least one descending section 16 of the conveyor belt 2. Specifically, the apparatus 1 may have, at least in correspondence of the operative section 5, one or more intermediate idler members adapted to define one or more ascending sections 15 and one or more descending sections 16. The accompanying figures illustrate an arrangement of the apparatus 1 with a plurality of intermediate idler members interposed between the first and second terminal members 3, 4. The plurality of intermediate idler members is active at the conveyor belt 2 operative section 5: the plurality of intermediate idler members include a first group of intermediate idler members aligned along a first row F1, and a second group of intermediate idler members aligned along a second row F2. The first and second rows of intermediate idler members are placed, under an operative condition of the apparatus 1, at different heights adapted to define on the operative section 5 a plurality of ascending sections 15 and a plurality of descending sections 16; particularly, the first row F1 is placed at a height greater than the height of the second row F2 (see FIG. 4, for example). Actually, along each of said first and second rows F1, F2, a plurality of intermediate idler members are placed. At least a portion of the operative section 5 of the conveyor belt 2 is alternatively guided around an idler member of the first row and around an immediately following idler member of the second row, in order to provide the portion of the operative section 5 with a series of ups and downs defining said bends.

Advantageously, the intermediate idler members of the first row F1 are equidistant from each other along the advancement direction A of the conveyor belt 2; in the same way, also the intermediate idler members of the second row F2 are equidistant from each other along the advancement direction A of the conveyor belt 2. Optionally, the minimum distance between two adjacent intermediate idler members of the first row F1 is substantially equal to the distance present between two adjacent intermediate idler members of the second row F2. In a preferred arrangement, the idler members of the first row F1 are offset from the idler members of the second row F2 along the advancement direction A of the belt 2 itself; particularly, the distance between the idler members of the first and second rows and the offset between these members provide at least one ascending section 15 and/or one descending section 16 of the conveyor belt 2 having a slope, with respect to a vertical plane, between 0 and 30°, preferably between 0 and 15°.

In this way, each conveyor belt 2 portion extending between two following intermediate idler members of the first row F1 and an intermediate idler member of the second row F2, comprises a respective descending section 16, a respective ascending section 15 and a respective lower junction section 33 interposed between and connected to said descending and ascending sections; the descending, junction, and ascending sections 16, 33, 15 of each belt portion 2 delimits a respective bend.

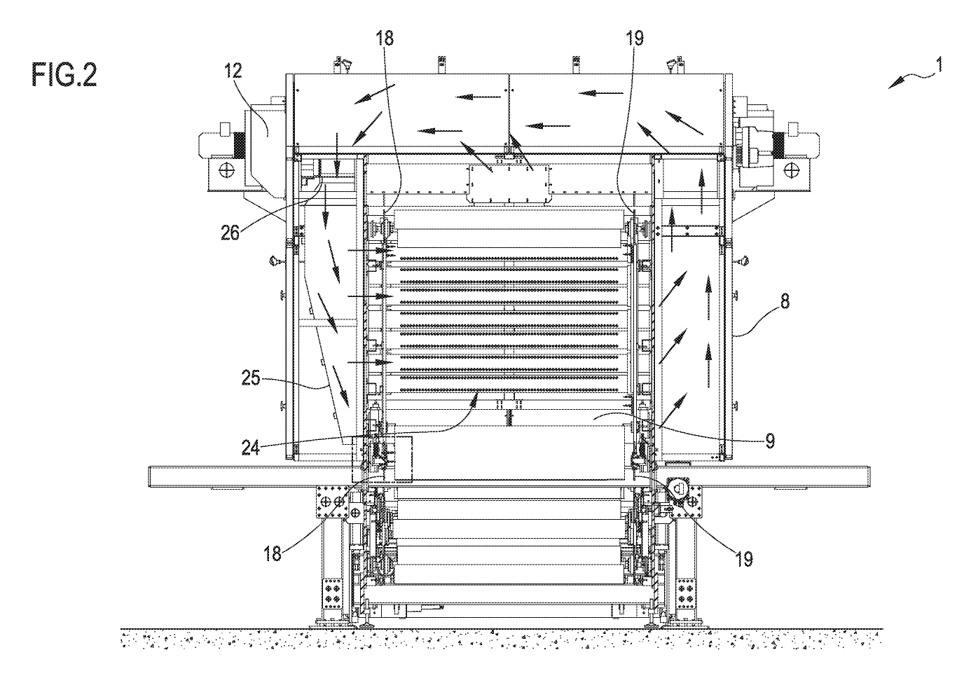

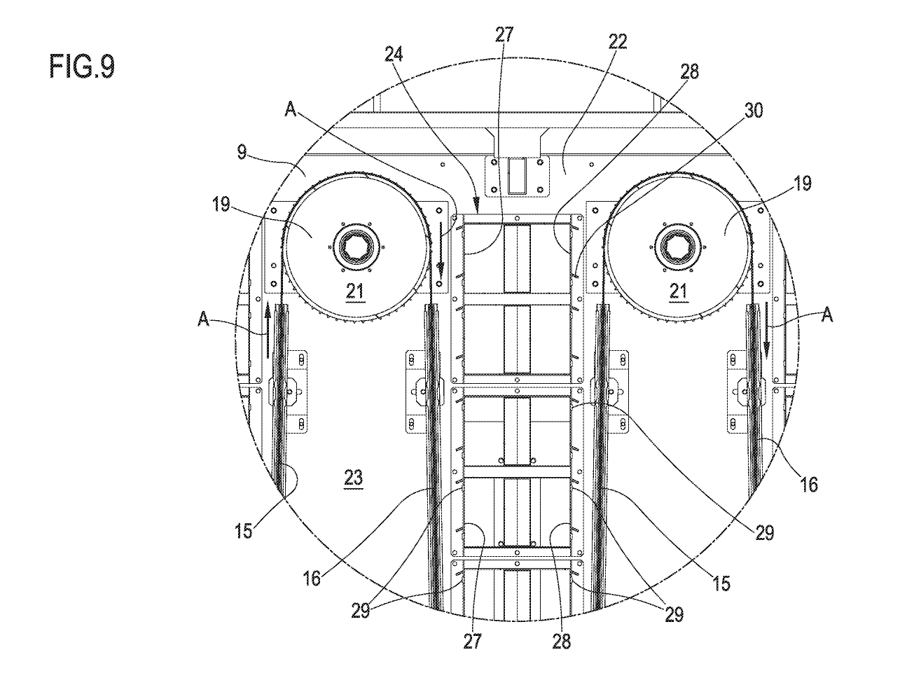

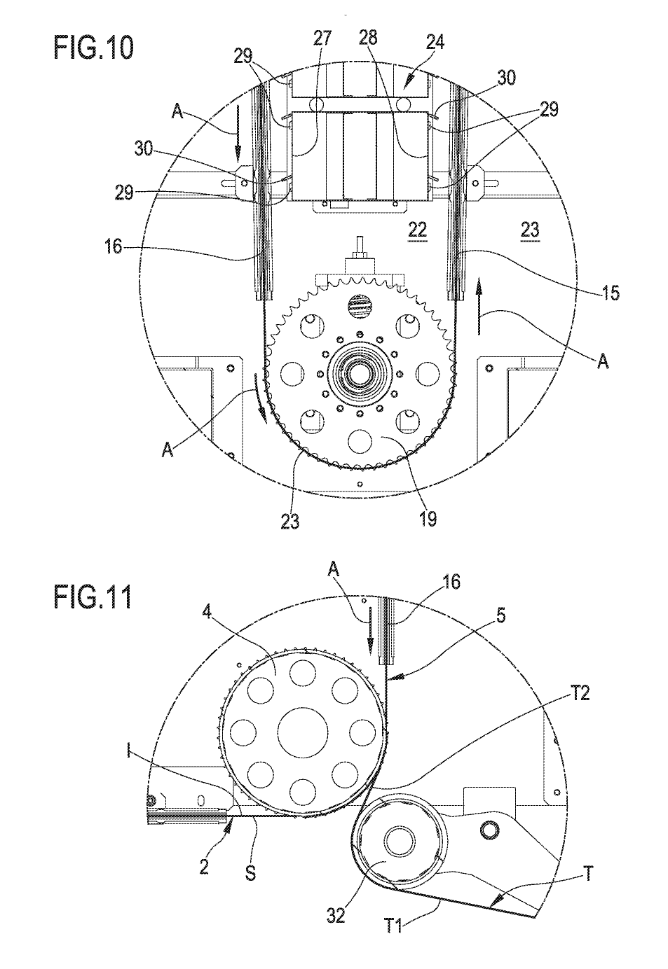

As previously described, the operative section 5 represents the belt 2 portion supporting the sheet fibrous material T; the descending, ascending and junction sections 16, 15, 33 are configured for receiving the sheet fibrous material T by facing it towards the interior of said respective bend (see the detail in FIG. 9, for example). One or more motors 35 active on one or more idler members of the apparatus 1 operate the conveyor belt 2 and therefore the sheet material T. More particularly, each idler member, both intermediate and terminal, has first and second guiding portions 18, 19 (FIG. 2), for example a crown wheel or gear wheel, active on the conveyor belt 2 and respectively arranged in correspondence of the opposite longitudinal edges of the conveyor belt 2, adjacent the edges. A dragging device 20, such as chain or belt, is active on each of the guiding portions 18, 19 of all the apparatus 1 idler members: the dragging device 20 extends all along the closed path of belt 2 and dynamically connects all the idler members. Activating a crown wheel or gear wheel of an idler member by the motors 35 enables, via the dragging device 20, movement of all the idler members and therefore movement of belt 2 along the operative path.

The accompanying figures illustrate an example having a single motor 35 active on a single intermediate idler member. However, it is possible to activate a plurality of motors on respective idler members.

Conveyor belt 2 is configured to have a width greater than the maximum width of the sheet fibrous material T; preferably, conveyor belt 2 has at least one first and one second dragging portions 17 on opposite longitudinal sides of the sheet fibrous material T. As described, the apparatus may have at least one dragging device 20 active on at least one of said first and second dragging portions 17 of the conveyor belt 2; preferably, such dragging portions 17 are engaged with the dragging device 20 which, as described, is in turn moved by one or more guiding portions 18, 19. The dragging device 20 may be alternatively active on the inner surface I of the belt 2 itself, opposite to the exposed surface S (this arrangement is not illustrated). Anyway, the dragging device 20, as all the elements adapted to move the belt 2, is configured for moving the belt 2 itself without contacting the exposed surface S, and therefore the sheet fibrous material T.

As described, conveyor belt 2 can define at least, at the operative section 5, a plurality of bends; particularly, the bends are defined by the alternative movements through the path formed by the intermediate idler members of the first and second rows. In a preferred arrangement, each intermediate idler member of the first row F1 (the upper idler member) comprises an idler roll or drum 21 configured for directly contacting the inner surface I of the conveyor belt 2 for guiding it along at least one portion of the operative section 5. The roll or drum of the first row therefore supports the conveyor belt 2 when passing from the ascending section 15 to the descending section 16 of the bend. The intermediate idler members of the second row being alternatively devoid of rolls or drums; at the junction section 33, the conveyor belt 2 is dynamically guided only by the dragging device 20, active only on the belt 2 portions 17, and the guide portions 18, 19 beside the belt 2. At junction portion 33, the belt 2 is only constrained and moved by the lateral dragging portions 17: in this way, it is possible to prevent the sheet fibrous material T, supported by belt 2, from contacting the moving elements of the dragging portions.

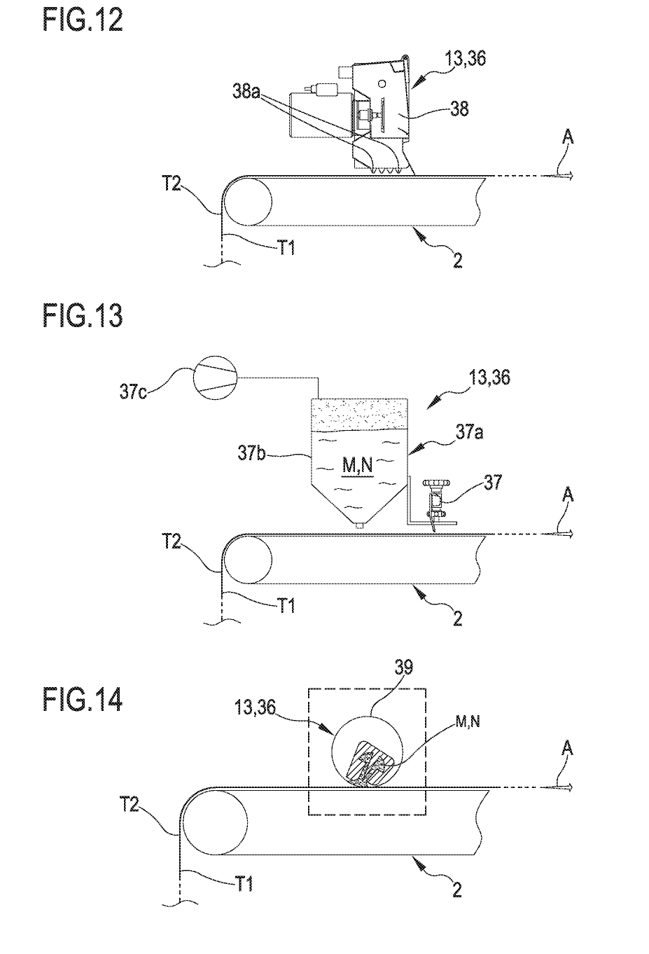

As is visible in the attached figures, the apparatus 1 also includes an applicator 13 configured for placing, on at least one first side T1 of the sheet material T and/or on the exposed surface S of the conveyor belt 2, an adhesive material M capable of constraining, at least temporarily, the sheet fibrous material T to the conveyor belt 2; preferably, the applicator 13 applies a continuous layer of adhesive material on the first side T1 of the sheet fibrous material T, and/or on the exposed surface S of the conveyor belt 2. In the illustrated embodiment, the applicator 13 applies an adhesive material continuous layer only on the exposed surface S of the conveyor belt 2, having a width at least equal to the width of the sheet fibrous material T or equal to the width of a portion to be printed of the sheet material. More specifically, the applicator 13 can include, for example, a spreading blade, a spray dispenser, a roll, a drum, or a distributor. FIGS. 12-16 show different examples of applicator 13.

In a first example, applicator 13 includes a spray dispenser (FIG. 12) spaced above the conveyor belt. In this configuration, the adhesive material may be, for example, a treatment liquid. The applicator 13 may include only one spray dispenser 38 extending along the whole width of the belt conveyor 2 and having a plurality of nozzles 38a that allow the dispenser 38 to apply the adhesive material (liquid) over the entire width of the belt 2, or the applicator 13 may include a plurality of spray dispensers 38, each of which has one or more dispensing nozzles 38a, configured to allow the application of adhesive material M on the entire width of the belt 2.

In a second example, the applicator 13 includes a spreading blade 37 (FIG. 13) placed transversally to the motion of the conveyor belt 2 and spaced above the belt 2. The spreading blade 37 may be associated with a distributor 37a of adhesive material M configured to place on the belt 2 a predetermined amount of adhesive material M. The blade 37 is placed immediately downstream of the distributor 37a according to the direction of advancement A of the belt and spreads on the belt surface the adhesive material M dispensed from dispenser 37a. A spreading blade may advantageously be used for spreading a material M comprising a treatment foam.

FIG. 13 shows a preferred example of the distributor 37a comprising a pressurized tank 37b inside of which the material M is present; the pressurized tank 37b is in fluid communication with a compressor 37c configured to introduce pressurized air to the tank 37b so as to allow dispensing of the adhesive material M. In a preferred configuration, apparatus 1 comprises a control unit 34 active on the compressor and 37c configured to:
receive from a sensor a signal relating to an operating parameter representative of at least one of: an internal pressure in the tank 37b, a level of material M inside the tank,
determine, as function of said signal, the amount of material being delivered from the tank,
compare the value for the amount of material being delivered with an optimal value, and
as function of said comparison, command the compressor to control the amount of material being dispensed from the tank.

In a third example, the applicator 13 comprises a drum 40 placed with its axis of rotation transverse to the motion of the conveyor belt 2 and with the side surface spaced above the belt 2 (FIG. 16). The drum 40 has a hollow interior to house a predetermined quantity of adhesive material M and is provided with a predetermined number of nozzles or slits for dispensing of the same. The drum 40 may be advantageously used for the application of an adhesive material M comprising a foam: in this configuration, the drum 40 can be powered by a foaming machine 44 configured to generate a predetermined amount of foam which is then sent into the drum 40 which will provide the delivery and spreading of the foam on the belt 2. In a preferred configuration, the control unit 34 is active on the foaming machine 44 and on the drum 40 and configured to:
receive from the sensor engaged to the belt 2, a signal relating to the movement of the conveyor belt 2,
control, as a function of said signal, a belt speed of the conveyor belt 2 along the advancement direction A,
as a function of the belt conveyor 2 speed, command the foaming machine 44 to supply a predetermined quantity of foam to the drum 40, and
as a function of the belt conveyor speed, control the rotation speed of the drum 40 so that the same drum may adequately spread the foam on the belt 2.

In a fourth example, the applicator 13 includes an applicator roll 39 with a respective associated blade for regulating a thickness of the adhesive material M deposited on a side surface of the applicator roll. Applicator roll and blade extend transversely with respect to the conveyor belt 2 and extend substantially for the entire width of said belt. The applicator roll is placed with its axis of rotation transverse to the motion of the conveyor belt 2 and with side surface spaced above the belt 2.

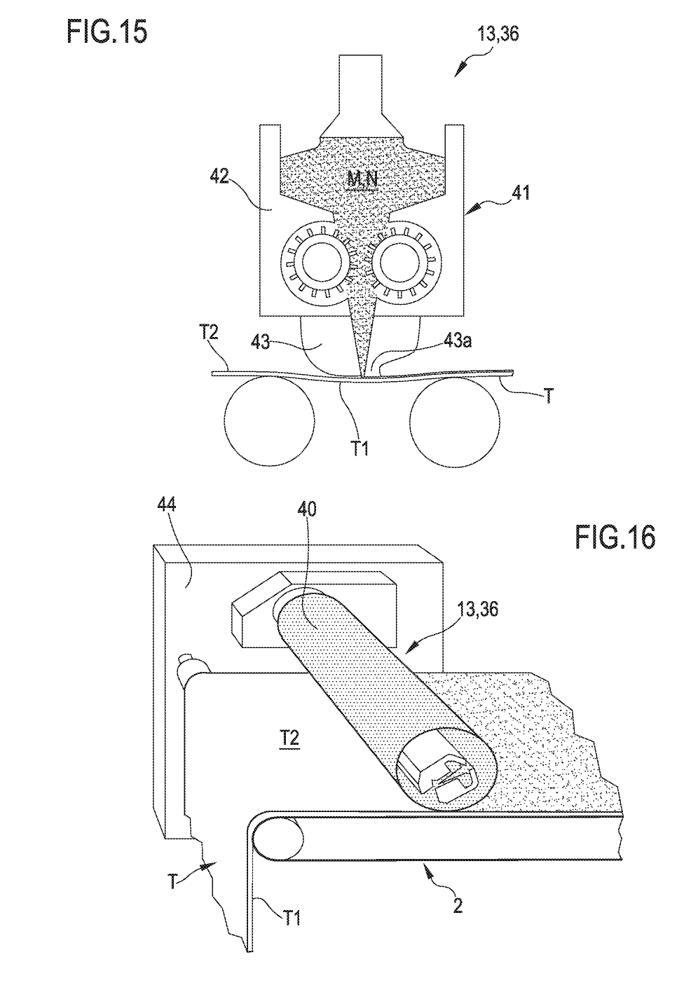

In a fifth example, the applicator 13 includes a distributor 41 with a tank 42 configured to receive the adhesive material. The tank 42 has at least a dispensing nozzle 43 positioned over and in contact with the belt 2: the nozzle 43 extends transversely to the conveyor belt 2 along the entire width of the latter. Inside the tank 42 is present at least one pusher, for example defined by a toothed wheel, configured to dispense the adhesive material M—for example a liquid or a foam—from the nozzle 43. As shown in FIG. 15, nozzle 43 is advantageously provided with a regulator 43a placed immediately downstream the exit of the adhesive material M, with respect to the advancement direction of the belt 2; the regulator 43a is configured to uniformly spread on the belt 2 the foam exiting from the nozzle 43.

As described above, apparatus 1 may advantageously include a control unit 34; in this configuration, the unit 34 may be active on the pusher of the distributor 41 to regulate the amount of adhesive material M to be delivered on the conveyor belt 2. In detail, the control unit 34 is connected to the pusher and is configured to:
receive, from the sensor engaged to the belt 2, a signal relating to the movement of the conveyor belt 2,
control, as a function of said signal, a speed of the conveyor belt 2 along the advancement direction A, and
as a function of the speed of the conveyor belt 2, regulate the pusher (for example in the case of a toothed wheel manage the rotation of the wheel speed) so as to deliver a predetermined quantity of material M on the belt.

The applicator 13 can be placed in any location of the operative path of the conveyor belt 2. For example, in FIGS. 4 and 5 the applicator 13 is interposed between the first and second terminal idler rolls 3, 4 just at the operative section. Under such condition, for applying the adhesive material and for then constraining the sheet fibrous material T on said belt 2, apparatus 1 will be provide the conveyor belt 2 with a motion along the operative path and for applying the adhesive material on the exposed surface S; only after a predetermined number of runs of the belt 2 around the closed path—during such runs the exposed surface is glued—the first side T1 of the sheet material T is placed in contact with the exposed surface S for constraining it to the belt 2.

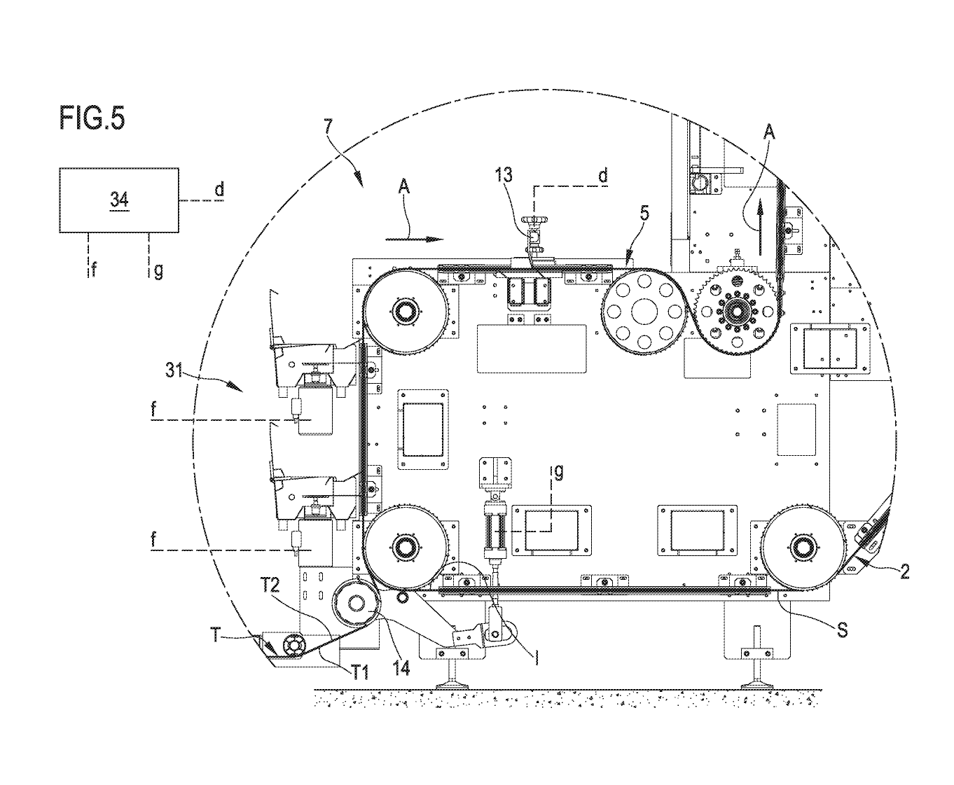

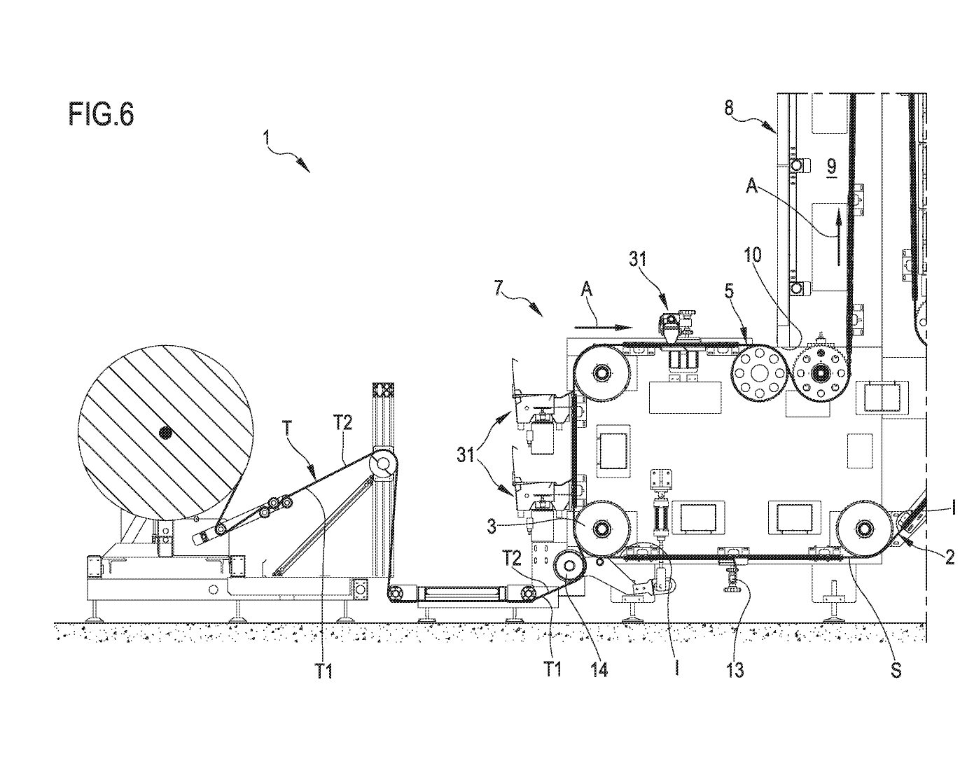

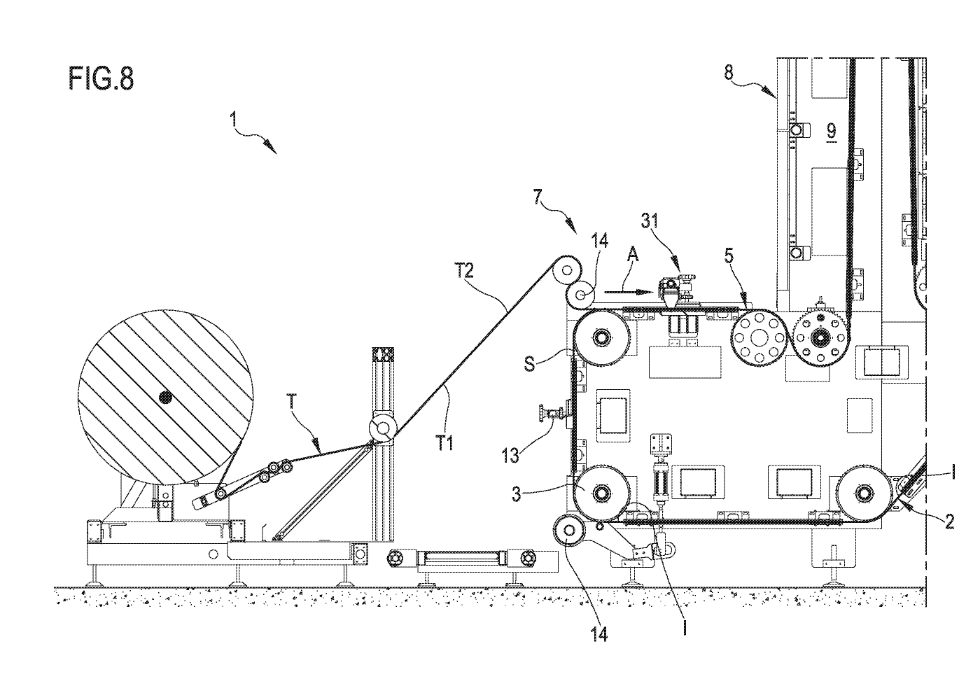

A further arrangement of the apparatus 1 is alternatively illustrated in FIGS. 6 and 8, in which the applicator 13 is placed between the first and second idler rolls 3, 4 downstream, particularly immediately downstream, the operative section 5. In this arrangement, the applicator 13 can place the adhesive material on the exposed surface S which can immediately receive the sheet material for defining the operative section 5: in comparison with the first described arrangement, the belt 2 is not required to move for one or more runs around the closed path before having the possibility of constraining the sheet material to the belt 2.

Apparatus 1 can have an inlet station 7 comprising a pressure member 4, specifically a pressure roll or drum (see FIGS. 5-8, for example), configured for receiving the sheet fibrous material T and for thrusting it against the conveyor belt 2 exposed surface S to at least temporarily fix the conveyor belt 2 to the sheet fibrous material T.

Pressure roll 14 determines the contact point between the sheet fibrous material T and belt 2 and therefore the starting point of the operative section 5. FIG. 5 illustrates a first arrangement of apparatus 1 in which the pressure roll 14 is placed upstream of applicator 13 with respect to the belt advancement direction A, while FIG. 8 illustrates a variant in which the pressure roll 14 is placed downstream of applicator 13 with respect to the belt 2 advancement direction A.

Apparatus 1 also has a station 31 for preparing the sheet fibrous material T by applying at least on a second side T2 of the sheet fibrous material T, opposite the first side T1, a treatment liquid or a treatment foam N. Preparing station 31 is configured to apply on the side opposite to the one fixed to the belt 2 (first side T1) a treatment liquid or a treatment foam N, preferably continuously across the entire width of the sheet fibrous material T. In the illustrated examples, preparing station 31 is placed in correspondence of the operative section 5: providing the treatment liquid or treatment foam N on the second side T2 of the fibrous material T is done when material T is constrained—preferably suitably fixed—to the conveyor belt 2. Therefore, generally the preparing station 31 is placed downstream, preferably immediately downstream, of pressure member 14 and can be considered as a portion of the inlet station 7. However, it is not excluded the possibility of positioning the preparing station 31 outside the operative section 5, and particularly upstream of pressure roll 14. In such an arrangement, it is possible to perform the treatment of the sheet material T before fixing the material to the belt 2 (this arrangement is not illustrated in the figures). For example, preparing station 31 can include a spreading blade, a spray dispenser, a roll, a drum, or a distributor.

In a first example, the applicator 36 of the preparing station is a spray dispenser 38 (FIG. 12) spaced above the fibrous sheet material. In this configuration, the applicator 36 is advantageously configured to dispense a treatment liquid of treatment foam; it is not excluded, the possibility to use a spray dispenser 38 for dispensing a treatment foam. The applicator 36 may include only one spray dispenser 38 extending along the entire width of the conveyor belt 2 and having a plurality of nozzles 38a that allow the dispenser 38 to apply the treatment liquid or the treatment foam over the entire width of the material fibrous sheet T, or the applicator 36 may include a plurality of spray dispensers, each of which has one or more dispensing nozzles 38a configured to allow the application of the treatment liquid or foam N over the entire width of the fibrous sheet material T.

In a second example, the applicator 36 of the preparing station 31 is a spreading blade 37 (FIG. 13) placed transversally to the motion of the conveyor belt 2 and spaced above the fibrous sheet material. The spreading blade 37 may be associated with a distributor 37a configured to supply on a portion of the second side T2 of the fibrous sheet material T a predetermined amount of treatment liquid or foam N. The spreading blade 37 is placed immediately downstream of the distributor 37a according the advancement direction A of the fibrous sheet material T and is configured to spread on the second side T2 of the sheet material T the treatment liquid or foam N dispensed from the dispenser 37a. A spreading blade may be advantageously used for spreading treatment foam. FIG. 13 shows a preferred embodiment of the distributor 37a having a pressurized tank 37b in which the treatment liquid or foam N is present; the pressurized tank 37b is in fluid communication with a compressor 37c configured to introduce pressurized air in the tank 37b so as to allow the dispensing of the treatment liquid or foam N. In a preferred configuration, the apparatus 1 comprises a control unit 34 activate on the compressor and 37c configured to:
receive from a sensor a signal relating to an operating parameter representative of an internal pressure in the tank 37 and/or a level of a treatment liquid or foam N inside the tank,
determine, as a function of said signal, the amount of treatment liquid or foam N being delivered from the tank,
compare the value of the amount of the treatment liquid or foam being delivered with an optimum value, and
based on the outcome of the comparison, command the compressor so as to control the amount of treatment liquid or foam N being dispensed from the tank.

In a third example, the applicator 36 of the preparing station 31 has a drum 40 placed with its rotation axis transversal to the motion of the conveyor belt 2 and with the side surface spaced above the fibrous sheet material (FIG. 16). The drum 40 has a hollow interior to house a predetermined quantity of treatment liquid or foam N and is provided with a predetermined number of nozzles or slits for dispensing the same. The drum may advantageously be used for applying a treatment foam: in this configuration, the drum 40 may be powered by a foaming machine 44 configured to generate a predetermined amount of foam, which is then supplied into the drum 40 that will provide the delivery, and spreading of the foam on the fibrous sheet material T. In a preferred configuration, the control unit 34 is active on the foaming machine 44 and on the drum 40 and is configured to:
receive, from the sensor engaged to the belt 2, a signal relating to the movement of the conveyor belt 2,
control, as function of said signal, a speed of the conveyor belt 2, and consequently a speed of the fibrous sheet material T along the advancement direction A,
as a function of the speed of the conveyor belt 2, command the foaming machine 44 for sending a predetermined quantity of foam to the drum 40, and
as a function of the speed of the conveyor belt 2, control the rotation speed of the drum 40 in such a way that the same may uniformly spread the foam on the fibrous sheet material T.

In a fourth example, the applicator 36 of the preparing station 31 has an applicator roll 39 associated with a respective spreading blade for regulating a thickness of the treatment liquid or foam N deposited on a side surface of the applicator roll. Applicator roll and spreading blade extend transversely with respect to the conveyor belt 2 and substantially for the entire width of said belt. The applicator roll is placed with its rotation axis transversal to the motion of the conveyor belt 2 and with side surface spaced above the fibrous sheet material.

In a fifth example, the applicator 36 of the preparing station 31 has a distributor 41 with a tank 42 configured to receive the treatment liquid or foam N. The tank 42 has at least a dispensing nozzle 43 positioned over and in contact with the fibrous sheet material T: the nozzle 43 extends transversely to the conveyor belt 2 along the entire width of the latter. Inside the tank 42 at least one pusher, for example defined by a toothed wheel, is present and configured to eject the treatment liquid or foam N through the nozzle 43. As can be seen from FIG. 15, the nozzle 43 is advantageously provided with a regulator 43a located immediately downstream the exit of the treatment liquid or foam N, with respect to the advancement direction A of the fibrous sheet material T; the regulator 43a is configured to substantially uniformly spread the treatment liquid or foam N exiting from the nozzle 43 on the fibrous sheet material T.

As described above, apparatus 1 may advantageously have a control unit 34; in this configuration, the unit 34 may be active on the pusher of distributor 41 for controlling the amount of treatment liquid or foam N to be dispensed on the conveyor belt 2. In detail, the control unit 34 is connected to the pusher and is configured to:
receive, from the sensor engaged to the belt 2, a signal relating to the movement of the conveyor belt 2,
control, as function of said signal, a speed of the conveyor belt 2, and consequently a speed of the fibrous sheet material T along the advancement direction A, and
as function of the speed of the conveyor belt 2, control the pusher (for example in the case of a toothed wheel by controlling the rotation of the wheel speed) so as to deliver a predetermined amount of liquid or treatment foam N on the fibrous sheet material T.

In a preferred embodiment of apparatus 1, the preparing station 31 includes an applicator 36 configured to apply on the second side T2 of the fibrous sheet material T a quantity of treatment foam; the applicator 36 is configured to dispense on the fibrous sheet material a quantity of foam having, immediately downstream of the applicator 36, a thickness less than 2 mm, preferably less than 1.5 mm. The applicator 36 may have a configuration as illustrated in FIGS. 12 to 16 and as described above. These foam applicators are fed by a foaming machine 44 (see, for example, FIG. 16) configured to generate the treatment foam and supply it to the applicator 36, either continuously or at predetermined time intervals, prefixed amounts of treatment foam.

In greater detail, the preparing station 31 is configured to dispense, on the second side T2 of the fibrous sheet material T, a quantity of foam selected in such a way that the same fibrous sheet material T present a percentage variation in weight per square meter, between a section immediately upstream of the applicator 36 in which the fibrous material has not received the foam and a section immediately downstream in which the fibrous material has received said foam, between 10% and 50%.

Advantageously, the foam applicator 36 of the preparing station 36 is configured to define on the second side T2 of the fibrous sheet material a continuous foam layer adapted to cover at least partially the second side T2 of the fibrous sheet material T, or a plurality of discrete foam regions defined on the second side T2 of the fibrous sheet material T and entirely surrounded by fibrous material not covered with foam.

As described above, apparatus 1 may have a control unit 34 active at least on the conveyor belt 2 and on the foam applicator 36 of the preparing station 31. The control unit 34 is configured to:
command the movement of the conveyor belt 2,
receive a desired value of at least one operating parameter representative of an amount of treatment foam to be applied on the fibrous sheet material, said at least one operating parameter comprising at least one of:
   a percentage variation in weight per area of the fibrous sheet material between a section immediately upstream of the applicator 36, where the fibrous material has not received the foam, and a section immediately downstream of the applicator 36, where the fibrous material has received the foam,
   a volume flow rate of the treatment foam exiting said applicator 3,
   a mass flow rate of the treatment foam exiting said applicator 36, and
   a foam thickness at the section immediately downstream of the applicator 36, and
command the foam applicator 36 so as to control the application of the treatment foam on the fibrous sheet material T, as a function of the desired value of the operating parameter and the movement imparted to said conveyor belt 2, and thus according to the speed of the fibrous sheet material T along the advancement direction A.

Preferably, the apparatus 1 has at least one sensor capable of emitting a signal related to the motion of the conveyor belt 2, and the control unit 34 is configured to:
receive from the sensor a signal relating to the movement of the conveyor belt 2,
determine, as a function of said signal, a movement speed of the fibrous sheet material T along the advancement direction A, and
as a function of the movement speed of the fibrous material T, control the treatment foam delivery to meet the desired value of said at least one operating parameter, optionally in such a way that the desired values of at least one of the following operating parameters are met:
   the foam present, immediately downstream of the applicator 36, has a thickness less than 2 mm, preferably less than 1.5 mm, and
   the percentage variation in weight per area of the fibrous sheet material, between a section immediately upstream of the applicator 36, where the fibrous material has not received the foam, and a section immediately downstream of the applicator 36, where the material fibrous received the foam, is between 10% and 50%.

Apparatus 1 also includes a separating member 32 placed in correspondence of a terminal portion of the operative section 5 (see FIGS. 4 and 11) and configured to contact at least one side of the sheet fibrous material T and to separate the material from the exposed surface S of the conveyor belt 2. Preferably, the separating member 32 is an element adapted to define the end of the operative section 5. The member 32 comprises at least one idler roll or drum adapted to contact the second side T2 of the sheet fibrous material T.

As visible in the accompanying figures, apparatus 1 also includes at least one drying station 6 placed near at least a portion of the operative section 5 and configured to at least partially dry the sheet fibrous material T passing near the station 6 itself. The drying station 6 includes one or more generators 12, optionally each consisting of a fan or compressor, configured to generate one or more corresponding gas flows that impinge upon at least a portion of the sheet fibrous material T fixed on the conveyor belt 2. Specifically, station 6 is configured for generating and emitting gas flows at a temperature less than 100° C., preferably between 60 and 100° C.

Advantageously, drying station 6 is placed immediately downstream from preparing station 31. In a preferred arrangement, the preparing station 31 and applicator 13 are both placed in correspondence of the inlet station 7: the station 31 and applicator 13 are immediately consecutive along belt 2 advancement direction A. Therefore, the drying station 6 is placed immediately consecutively to the inlet station 7 and therefore is placed immediately downstream from station 31 and applicator 13 along the belt 2 advancement direction A. The station 6 is configured to at least partially dry the sheet material T on which the treatment liquid was applied. In a preferred arrangement, drying station 6 substantially extends along all of operative section 5, preferably from the inlet station 7 to the separating member 32: under such arrangement the station 6 is adapted to blow a gas (for example air) substantially on all the sheet material T constrained on belt 2.

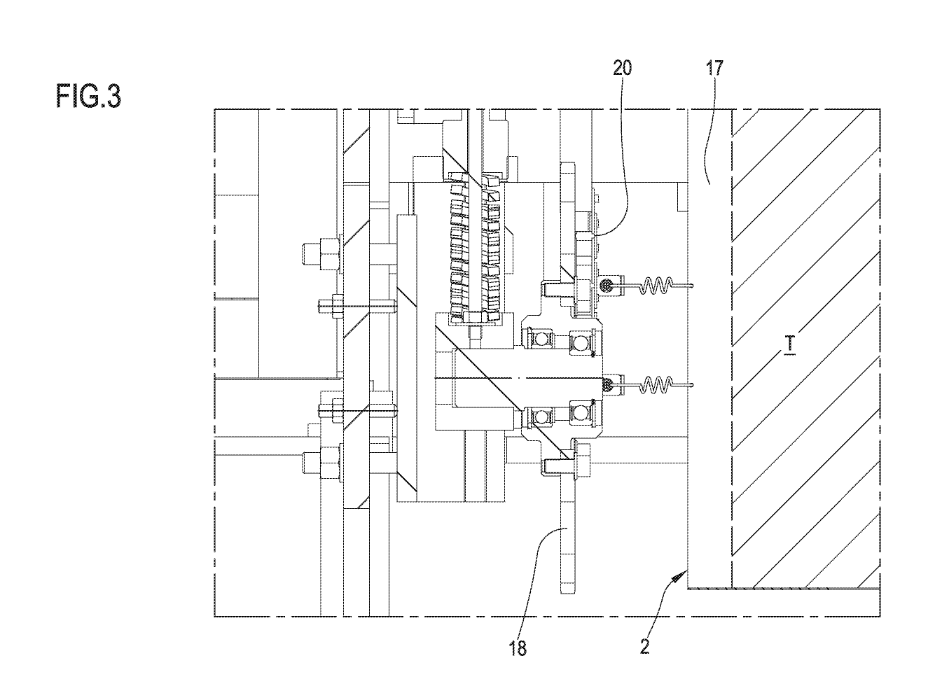

As shown in FIG. 3, drying station 6 has a plurality of gas distribution channels 24 connected to one or more generators 12. Each distribution channel 24 is configured for blowing a gas, preferably continuously, toward the exposed surface S of the conveyor belt 2, for progressively drying the sheet material T sliding on the operative section 5. Each distribution channel 24 can receive the gas flows from one or more generators 12. Advantageously, a plurality of distribution channels 24 uniformly distributed along the operative section 5 are present, each channel 24 configured for treating and then drying a portion of the sheet material T supported by the belt 2.

Advantageously, each generator 12 can supply a plurality of distribution channels 24, particularly a number of channels between 1 and 6, still more preferably between 1 and 4.

As described above, conveyor belt 2 can define, for at least a portion of the operative section 5, a plurality of bends; under such arrangement, the distribution channels 24 are placed in correspondence of said bends. Preferably, the distribution channels 24 are configured for blowing a gas at least at the bends, and specifically inside the bends. Advantageously, the drying station 6 comprises—for each of a plurality of bends—at least one respective distribution channel 24 placed inside the bend defined by the conveyor belt 2: each distribution channel 24 is therefore configured to emit a gas flow towards the sheet fibrous material T supported by the exposed surface S (FIG. 4). More preferably, each distribution channel 24 has first and second emitting walls 27, 28 respectively facing the exposed surface S of the descending section 16 and ascending section 15 of the conveyor belt 2: each emitting wall 27, 28 defining a plurality of through openings 29 that emit gas flows toward the sheet fibrous material T of the bend. Advantageously, the emitting walls extend along all the conveyor belt 2 width and, particularly, substantially along the height of the bends. The emitting walls 27, 28 extend substantially from the idler members of the first row F1 (upper row) to the idler members of the second row F2 (lower row). The through openings 29 are distributed on each emitting wall 27, 28 along rows transversal, preferably normal, to the advancement direction A of the conveyor belt 2; optionally, the openings 29 rows are, according to an operative condition of the apparatus 1, substantially horizontal.

As shown in the cross-section view of FIG. 3, the through openings 29 are substantially evenly placed on each emitting wall 27, 28 in order to substantially define a regular array of openings 29: in this way, the air flows exiting the openings 29 of the emitting walls 27, 28 can uniformly dry the sheet material T supported by the ascending wall 15 and descending wall 16 of the belt 2.

Advantageously, the distribution channel 24 has one or more flaps 30 (FIG. 9) arranged to direct at least a portion of the gas flow exiting the channel 24 itself and to generate one or more respective gas flows having a component, particularly a main component, parallel to the exposed surface S of the conveyor belt 2. Advantageously, each distribution channel 24 has, on both the emitting walls 27, 28, a series of flaps 30 adapted to contact the air flow exiting from all the openings 29 so that all the flows exiting the channel have a component parallel to the exposed surface S. Such an arrangement generates, at least for the ascending and descending sections of the belt, air flows having a component parallel to the sheet fibrous material T: the parallel component provides withdrawal of moisture of the fibrous material T and therefore to effectively dry the material.

As shown in FIG. 2, drying station 6 has an inlet conduit 25 connected to one or more generators 12 and distribution channels 24: the inlet conduit 25 is placed laterally to the conveyor belt 2 and extends at least along a main portion of, optionally all, the vertical extension of the distribution channel. The conduit 25 is configured for receiving gas flows from one or more generators, and conveying them (sending a gas flow) to the distribution channel 24. The conduit 25 is configured for providing a gas flow with a direction transverse, particularly normal, to the advancement direction A of the conveyor belt 2. The gas flow is introduced from the conduit 25 laterally in the channel 24 that, in turn, generates flows directed towards the exposed surface S.

FIG. 3 illustrates a preferred arrangement of the inlet conduit 25 extending along all the height of the distribution channels 24 from an inlet mouth 26 adapted to receive the flow from the generator 12, substantially placed in correspondence of the first row F1 of the idler members.

Further, the conduit 25 defines one or more service openings connected—for example directly—to the distribution channel 24 and beside the conveyor belt 2; the service openings are configured for delivering the gas to the channel 24.

Advantageously, the conduit 25 has a gas passage cross-section at least partially decreasing from the inlet mouth 26 advancing downwards along a development of the same inlet conduit 25. In this way, since the gas flow enters at the mouth 26 placed on the top of the conduit 25, the downwards decreasing section trend is adapted to enable to emit gas flows from the service openings at the same speed: the gas flow introduced at the top of the channel 24 has a speed substantially equal to the speed of the gas flow introduced in the channel at a bottom portion. The conduit 25 decreasing trend is configured for countering the load losses generated by the same conduit in order to enable to emit gas flows having all the same speed: the channel 24 receives—along all its vertical extension—gas flows at the same speed. In a preferred arrangement, the distribution channel 24 has also a gas passage cross-section at least partially decreasing from the service openings (the gas flows inlet) along the inlet conduit 25, transverse to the conveyor belt 2.

Each distribution channel 24 has, along the width development, a decreasing passage cross-section.

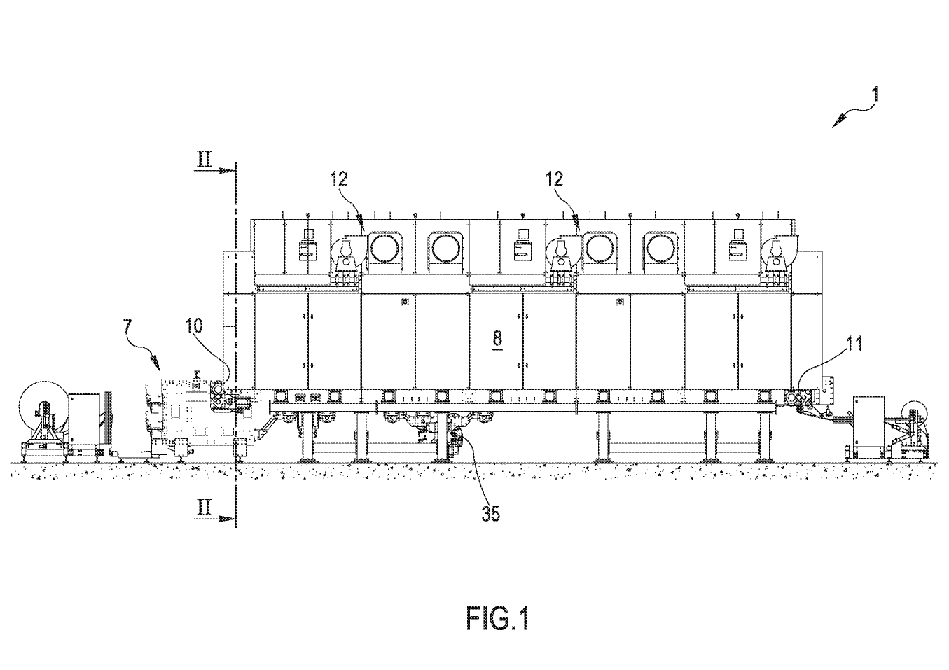

Further, drying station 6 can include a casing 8 defining at least one treating chamber 9 inside which at least a portion of the operative section 5 extends. As shown in FIG. 1, casing 8 comprises an inlet port 10 configured for constantly enabling the passage of a section of the conveyor belt 2 entering the treating chamber 9, and an outlet port 11 configured for constantly enabling the passage of a section of the conveyor belt 2 exiting the treating chamber 9. In a preferred embodiment, casing 8 extends mainly along the operative section 5 from the inlet station 7 to the separating member 32 (FIGS. 1 and 4). The inlet port 10 of the casing 8 is placed immediately downstream, along the advancement direction A of the belt 2, of the preparing station 31, or of the applicator 13. A portion of the operative section 5 crosses the treating chamber 9 so that the longitudinal extension of the portion of the operative section 5, inside the treating chamber 9, is greater than the maximum distance between the inlet port 10 and outlet port 11 of the casing 8.

FIG. 4 shows an arrangement of the apparatus wherein the bends operative section 5 is completely placed inside and is defined inside the treating chamber 9 (the bends extend along all the operative section 5 inside the treating chamber 9). In such arrangement, each of said distribution channels 24 is placed inside the casing 8 and is configured for blowing a gas on the operative section 5 inside the treating chamber 9. As shown in FIGS. 4 and 9, the operative section 5 of the conveyor belt 2 crossing the 8 longitudinally separates the treating chamber 9 into first and second half-chambers 22, 23; the first half-chamber 22 extends above the exposed surface S of the belt 2, while the second half-chamber 23 extends below an inner surface I of the conveyor belt 2 opposite to said exposed surface S: the drying station 6 directs a gas flow inside the first half-chamber 22 (for example through the distribution channels 24 supplied by one or more generators 12) towards the sheet fibrous material T temporarily fixed to the exposed surface S of the conveyor belt 2.

From the dimensional point of view, the operative section 5 of the conveyor belt 2 has a perimetral extension—measured along the advancement direction of the belt itself—greater than 20 meters, preferably greater than 30 meters, still more preferably greater than 50 meters. The operative section 5 placed inside the treating chamber 9 has a perimetral extension—measured along the advancement direction of the belt itself—greater than 15 meters, preferably greater than 30 meters, still more preferably greater than 50 meters. Substantially all the operative section 5 is defined by and contained in the treating chamber 9, inside which a gas is blown for at least partially drying the sheet fibrous material.

In a preferred example, the apparatus 1 also has a control unit 34 (FIG. 5) active on the conveyor belt 2, preferably on the motor 35 that moves the belt 2, and is configured for commanding the movement of the belt. Preferably, the control unit 34 is configured for controlling the motor 35 in order to manage the belt 2 moving speed along the closed path.

Further, the control unit 34 is active on the drying station 6 and is configured for commanding the station 6 itself and determining a drying gas emission directed at least in correspondence of said operative section 5 of the conveyor belt 2: the control unit 34 is configured for managing therefore the airflows hitting the fibrous material.

Preferably, the control unit 34 is configured for controlling the moving speed of said conveyor belt 2 and commanding the drying station 6 so that a same section of the sheet fibrous material T is subjected to said gas emission for a time between 30 and 240 seconds, preferably between 30 and 120 seconds, still more preferably between 30 and 90 seconds. More specifically, the control unit 34 is configured for moving the conveyor belt 2 at a speed greater than 20 meters/min, preferably greater than 30 meters/min, still more preferably greater than 40 meters/min. The control unit 34 can substantially control the drying degree of the sheet fibrous material T by controlling the belt 2 sliding speed and the gas flow generators.

Moreover, apparatus 1 can include an ink-printing station (not shown) placed downstream the operative section 5—preferably downstream from separating roll 32—of the conveyor belt 2. The printing station is configured for receiving the sheet material T arriving from the operative section 5 and ink-printing at least the second side T2 of the sheet fibrous material T. More particularly, the printing station is configured for receiving the sheet material T after exiting the belt 2 closed path and after pre-treatment and drying. The printing station, for example a digital ink-printing station, can therefore be placed immediately downstream of the casing—along an advancement direction of the fibrous material—and configured for continuously receiving the material T exiting the casing 8. Alternatively, apparatus 1 can provide a station collecting a predetermined amount of the treated and dried fibrous material; the printing station therefore could be configured for receiving, by a load batch, the fibrous material of the collecting station.

A process of treating a sheet fibrous material T using apparatus 1 includes moving the conveyor belt 2 along a closed operative path. The belt 2 can be moved between the first and second terminal idler rolls 3, 4; the movement is performed by means or one or more motors 35 directly active on the idler members or directly active on the dragging device 20. The conveyor belt 2 defines the operative section 5 conveying the sheet fibrous material; the operative section 5 of the belt 2 is defined by the belt 2 portion moving the sheet fibrous material T, in other words by the belt 2 portion directly supporting said fibrous material T. The conveyor belt 2, and consequently the sheet fibrous material T, are moved at least partially by pulling the belt 2 from the dragging portions 17 transversally emerging from opposite longitudinal sides of the sheet fibrous material T. Alternatively, the dragging device 20 is moved by a plurality of guiding portions 18, 19 placed beside the belt 2. Each guiding portion 18, 19 engages a device 20 that laterally engages the belt 2 in correspondence of the lateral portions 17: activating one or more guiding members 18, 19 moves the device 20 and consequently belt 2. Therefore, the sheet fibrous material T, at least along the operative section 5, is moved only by moving the conveyor belt 2: the sheet fibrous material T, during the movement along all the operative section 5, is directly and only contacted by the exposed surface S of the conveyor belt 2. From the quantitative point of view, the step of moving the conveyor belt 2, and therefore the sheet fibrous material T, along the operative section 5, is done at a speed of 20 meters/min, preferably greater than 30 meters/min, still more preferably greater than 40 meters/min. The belt 2 can be moved along an operative section 5 having at least a rectilinear flat section or having at least one difference in height. Advantageously, the operative section 5 defines, for at least a portion of its extension, a plurality of bends. The belt 2 movement along the operative section 5 follows a serpentine trend, in other words an up and down movement along ascending and descending sections 15, 16 of the bends. Preferably, conveying the belt 2 and fibrous material T along the operative section 5 can move the belt 2 between at least one intermediate idler member adapted to define at least one ascending section 15 and one descending section 16 of the conveyor belt 2. More specifically, conveying the belt 2 and fibrous material T along the operative section 5 moves the belt 2 between a plurality of intermediate idler members. One or more intermediate idler members of said plurality are placed on at least one first upper row F1 while one or more intermediate idle members of said plurality are placed on at least one second lower row F2: the first and second rows of intermediate idler members are placed, according to an operative condition, at different heights in order to define, on the operative section 5, at least one ascending section 15 and one descending section 16. Still more particularly, a plurality of intermediate idler members are present on said first and second rows F1, F2. Moving the conveyor belt 2 provides, for at least a portion of the operative section 5, to slide the same belt from an idler member of a row to an immediately consecutive idler member of the other row along an advancement direction A of the conveyor belt; such motion of the conveyor belt 2, and therefore of the sheet fibrous material T, causes the belt to slide along a serpentine path. As described, each bend of the belt 2 has a descending, junction and ascending sections 16, 33, 15 in which the fibrous material T also shaped as a bend is supported: the bends are aligned along an advancement direction A of the conveyor belt 2.

The belt 2 can be moved along at least a portion of the operative section 5 inside a casing 8 defining a treating chamber 9: the operative section 5 inside the treating chamber 9 separates the casing 8 into first and second half-chambers 22, 23 respectively representing an upper half-chamber inside which the sheet material T slides, and a lower half-chamber. The step of moving the conveyor belt 2 inside treating chamber 9 slides the same belt 2 between the inlet port 10 and outlet port 10 so that the operative section 5 extends at least partially inside chamber 9.

Preferably, the longitudinal extension of the operative section 5 inside the treating chamber 9 is greater than the maximum distance between the inlet port 10 and outlet port 11 of the casing 8.

Moreover, the process provides constraining, particularly fixing, the sheet fibrous material T on the exposed surface S of the conveyor belt 2. Specifically, such step provides fixing at least temporarily the first side T1 of the sheet fibrous material T to the exposed surface S of the operative section 5 of the conveyor belt 2. More particularly, the step of fixing the fibrous material T to the belt 2 provides, before a step of contacting the conveyor belt 2 to the sheet fibrous material T, at least one step of providing an adhesive material on at least a portion of a first side T of the sheet material T and/or on an exposed surface S of the conveyor belt 2. The application of the adhesive material can be done, particularly continuously, during the conveyor belt 2 and/or sheet material T movement: the adhesive material is applied on a first side T1 of the sheet material and/or on an exposed surface S of the conveyor belt 2 along all the width of the sheet fibrous material T. The adhesive material is applied by means of an applicator 13 only on the belt 2 exposed surface S; the step of applying the adhesive material defines, on the exposed surface S, an adhesive material continuous layer adapted to stably constrain the fibrous material T, along its width, to the conveyor belt 2.

Still more preferably, the step of fixing the fibrous material T on the conveyor belt provides the application of an adhesive material on at least a portion of an exposed surface S of the conveyor belt 2 during movement of the belt along the closed path; afterward, the process provides to contact, particularly by means of the pressure member 14, the first side Ti of the sheet fibrous material T with the exposed surface S supporting the adhesive material by always continuously moving the conveyor belt 2 along the closed path: in this way, it is possible to fix the sheet fibrous material T to the conveyor belt 2. The adhesive is continuously applied to the belt 2, which is at the same time moved along the advancement direction A; the sheet material is placed in contact with the belt 2 only when the glued belt portion reaches the pressure member 14. In an embodiment variant of the process, the step of applying the adhesive material is continuously done for a predetermined number of runs of the belt 2 around the closed path, for example for a number of runs between 1 and 10. The step of contacting the fibrous material with the glued belt is performed only after the step of applying the material for a predetermined number of runs around the closed path.

After the step of fixing the fibrous material T to the belt 2 in order to define the operative section 5, the process provides preparing the sheet fibrous material T comprising the application on a second side T2 of the material T itself opposite the side fixed to the conveyor belt 2, of a treatment liquid or treatment foam. The treatment liquid or treatment foam is continuously applied along all the width of the sheet fibrous material T in order to define a layer covering substantially the whole exposed upper surface S of the sheet fibrous material. This latter step is performed by a preparing station 31, for example comprising at least one applicator roll or drum, at least one liquid spraying device, or at least one blade or a distributor. The preparing station 31 is placed in correspondence of the operative section 5 downstream the pressure member 14.

After preparing the sheet fibrous material, the process includes drying the material by blowing a gas during the passage of the material along at least a portion of the operative section 5. As described above, the belt 2 can be advantageously configured with bends; under such condition, the process provides to blow at least a gas flow inside the bends supporting the sheet fibrous material T. Blowing the gas on the sheet fibrous material T can be done by means of the plurality of distribution channels 24 aligned inside the bends along the operative section 5. The distribution channels 24 continuously emit a gas in order to progressively dry the fibrous material sliding along the operative section 5. More particularly, blowing the gas is done on at least the ascending and descending sections 15, 16 of the operative section 5 of the conveyor belt 2. As described above, each distribution channel 24 substantially extends along all the height of a bend and along the width of the sheet fibrous material T. Drying the fibrous material includes delivering the gas to each distribution channel 24 through the inlet conduits 25 placed beside the conveyor belt 2; the gas is supplied laterally into the distribution channel 24 with respect to the conveyor belt 2, and along a transverse direction, particularly normal, to an advancement direction of the conveyor belt 2. Each channel 24 generates a plurality of gas flows evenly distributed along all the width of the sheet fibrous material T and along the vertical extension of the bend; preferably, at least a portion of said flows has a component parallel to an exposed surface of the fibrous material sliding along the bend. From a quantitative point of view, the drying gas blown on the fibrous material T placed on the operative section 5, has a temperature less than 100° C., preferably between 60 and 100° C.

Drying the sheet fibrous material T can include moving at least a portion of the belt 2 inside a casing 8, between an inlet port 10 and an outlet port 11, defining a treating chamber 9. At least a fraction of the gas drying flows can be blown inside the treating chamber 9 so that the same can hit the sheet fibrous material sliding inside said chamber 9. Advantageously, the bends shaped operative section 5 is defined inside the treating chamber 9. The drying step can include blowing air—for example through the distribution channels 24—inside the chamber 9 and inside the bends.

A temperature less than 100° C., preferably between 60 and 100° C., is maintained inside the treating chamber 9 of the casing 8. The moving of the conveyor belt 2 is coordinated with the drying step so that the sheet material T is subjected, for a predetermined period of time, to the drying action. Preferably, the belt 2 is moved at a predetermined speed in order to subject a given section of the sheet fibrous material T to a gas flow drying emission for a time between 30 and 240 seconds, preferably between 30 and 120 seconds, still more preferably between 30 and 90 seconds.

Further, the process includes, following the drying step, separating the at least partially dried sheet fibrous material T exiting the operative section 5, from the conveyor belt 2 exposed surface; by such step, the first side Ti of the sheet material, previously fixed, is separated from the conveyor belt 2 exposed surface S, for example by a pressure roll and/or drum adapted to at least partially wind the second side T2 of the sheet fibrous material.

Moreover, the process can include a step of delivering the sheet material T, separated from the belt 2, previously treated and partially dried, to an ink-printing station for printing the material T.

The printing step includes the application of ink at least on the second side T2 on which the treatment liquid was applied, after being dried. The printing station can for example provide a digital ink printer that can receive, continuously or by a load batch, the sheet material T exiting from the operative section and therefore treated and dried.

1. A fibrous sheet material printing pre-treatment apparatus, comprising:
a conveyor belt movable along a closed path and having an exposed surface configured for receiving the fibrous sheet material, at least a portion of the closed path of said conveyor belt defining an operative section defining a plurality of bends,
an adhesive applicator configured to place on a first side of the sheet material and/or on an exposed surface of the conveyor belt, an adhesive capable of constraining the fibrous sheet material to the conveyor belt, and
a drying station operable over at least a portion of said operative section and configured to at least partially dry fibrous sheet material in the operative section, the drying station comprising a casing defining treating chamber in which the operative section extends, the casing defining an inlet port enabling continuous passage of the conveyor belt into the treating chamber, and an outlet port spaced from the inlet port and enabling continuous passage of the conveyor belt out of the treating chamber,
wherein a length of the operative section within the treating chamber is greater than a maximum distance between the inlet port and the outlet port of the casing.

2. The apparatus of claim 1, wherein the adhesive applicator is configured to apply a continuous layer of adhesive material only on the exposed surface of the conveyor belt, the applied layer having a width at least equal to a width of the fibrous sheet material to be printed.

3. The apparatus of claim 1, wherein the drying station comprises one or more airflow generators configured to direct one or more flows of gas to impinge upon an exposed surface of the fibrous sheet material fixed to the conveyor belt.

4. The apparatus of claim 1, comprising a plurality of intermediate idlers disposed inside treating chamber and active on the operative section, including a first group of intermediate idlers aligned according to a first row and a second group of intermediate idlers aligned according to a second row, said first and second rows positioned at different heights to define within the operative section a plurality of alternating ascending and descending sections along which the conveyor belt is constrained to travel in a series of bends.

5. The apparatus of claim 4, wherein the drying station is configured to blow air against the fibrous sheet material between adjacent bends.

6. The apparatus of claim 5, wherein the drying station comprises, for each of a plurality of said bends, a respective distribution channel positioned within the bend and configured to emit a gas flow toward the fibrous sheet material.

7. The apparatus of claim 6, wherein the drying station comprises an inlet conduit connected to one or more airflow generators and to the distribution channels, said inlet conduit configured to supply a gas flow to each distribution channel, the inlet conduit defining:
an inlet opening adapted to receive a gas flow from the one or more airflow generators and positioned at the top of the treating chamber,
service openings connected to respected ones of the distribution channels and configured to supply gas to the distribution channels, and
a gas passage cross-section that decreases from the inlet opening along an airflow direction.

8. The apparatus of claim 4, wherein the conveyor belt has a width greater than a maximum width of the fibrous sheet material, and comprises dragging portions arranged to extend laterally beyond opposite longitudinal sides of the fibrous sheet material, and
wherein the apparatus comprises a dragging device active on the dragging portions and configured to move the conveyor belt without contacting the exposed surface of the belt.

9. The apparatus of claim 8, wherein at least some of the intermediate idlers comprise guiding portions engageable by the dragging device to move the guiding portions and thereby move the conveyor belt at least along the operative section.

10. The apparatus of claim 1, wherein the exposed surface of the conveyor belt is devoid of through openings passing through the belt.

11. The apparatus of claim 1, comprising a control unit active on the conveyor belt and the drying station, and configured to control both movement of conveyor belt, and a gas emission directed to said operative section within the drying station.

12. The apparatus of claim 1, further comprising at least one treatment applicator configured to apply on a second side of the fibrous sheet material, opposite the first side, a treatment liquid or treatment foam, the treatment applicator comprising at least one of:
a spreading blade placed across the conveyor belt and above the fibrous sheet material,
a spray dispenser spaced above the fibrous sheet material,
an applicator roll with an associated blade adapted to regulate a thickness of treatment foam deposited on a lateral surface of the applicator roll, the roll spaced above the fibrous sheet material and having a rotation axis transverse to the conveyor belt,
a drum spaced above the fibrous sheet material and having a rotation axis transverse to the conveyor belt, the drum having a hollow interior configured to receive a predetermined quantity of treatment foam and a number of nozzles or slits for dispensing foam from the interior, and
a distributor comprising a tank configured to receive a predetermined quantity of treatment foam and having a dispensing nozzle defining an outlet of the tank, the nozzle extending transverse to the conveyor belt over an entire width of the belt, the distributor having a pump disposed inside the tank and configured to supply the treatment foam through the nozzle.

13. A method of treating a fibrous sheet material, the method comprising:
moving a conveyor belt along a closed path,
fixing at least temporarily a first side of a fibrous sheet material to an exposed surface of an operative section of the conveyor belt,
at least partially drying the fibrous sheet material by blowing gas on the fibrous sheet material during passage of the fibrous sheet material along bends defined by the operative section, and then
withdrawing the fibrous sheet material from the conveyor belt,
wherein moving the conveyor belt comprises moving the conveyor belt inside a treatment chamber, from an inlet port to an outlet port, such that the operative section extends at least partially inside the chamber, and
wherein a length of the operative section within the treatment chamber is greater than a maximum distance between the inlet port and the outlet port.

14. The method of claim 13, wherein fixing the fibrous material to the conveyor belt comprises:
applying an adhesive material on at least a portion of the exposed surface of the conveyor belt during the movement of the conveyor belt along the closed path, and
contacting a first side of the fibrous sheet material with the applied adhesive material while continuously moving the conveyor belt along the closed path.

15. The method of claim 13, wherein the conveyor belt is moved at a predetermined speed selected to subject a given section of the fibrous sheet material to a drying gas flow emission for a time between 30 and 240 seconds.

16. The method of claim 13, further comprising, after fixing the fibrous sheet material and before blowing the gas, applying on a second side of the fibrous sheet material, opposite the first side, a wet treatment material.

17. The method of claim 16, wherein the wet treatment material comprises a treatment foam.

18. The method of claim 17, comprising dispensing a predetermined quantity of the foam with a spray dispenser.

19. The method of claim 17, comprising spreading a predetermined quantity of foam with a spreader selected from the group consisting of:
a spreading blade transversally arranged to the motion of the conveyor belt,
an applicator roll having an associated respective spreading blade for regulating a thickness of the treatment foam deposited on a lateral surface of the applicator roll, said applicator roll having a lateral surface spaced above the conveyor belt and a rotation axis transverse to the conveyor belt, and
a drum having a lateral surface spaced above the conveyor belt and a rotation axis transverse to the conveyor belt, the drum defining a hollow interior configured to receive a predetermined quantity of treatment foam and defining a predetermined number of nozzles or slits for dispensing treatment foam from the interior.

20. The method of claim 17, comprising dispensing a predetermined quantity of foam with a distributor comprising:
a tank configured for receiving the treatment foam, the tank having at least one dispensing nozzle defining an outlet of the tank and extending across an entire width of the conveyor belt, and
a pump configured to supply treatment foam from the tank through the nozzle.
